(19) United States
(12) Patent Application Publication
(10) Pub. No.: US 2018/0186298 A1
(43) Pub. Date: Jul. 5, 2018

(54) Ladder Stop and Method

(71) Applicant: Thomas W. Parker, Jamestown, PA (US)

(72) Inventor: Thomas W. Parker, Jamestown, PA (US)

(21) Appl. No.: 15/395,332

(22) Filed: Dec. 30, 2016

(51) Int. Cl. B60R 9/048

(52) U.S. Cl. CPC B60R 9/0485

(57) ABSTRACT

A ladder stop for securing a ladder vehicle rack includes a hook that contacts the ladder and holds the ladder to the rack. The stop includes a clamp which removably attaches to the rack and from which the hook rotates and extends and moves up and down to hold the ladder. The stop includes a locking mechanism that locks the hook in a desired position. The stop includes a handle disposed adjacent a bottom of the hook for a user to grab and pull the hook down to secure the hook in place with the ladder. A method for securing a ladder to a vehicle rack.

### FIELD OF THE INVENTION

The present invention is related to a ladder stop which secures one or more ladders to a vehicle rack. (As used herein, references to the “present invention” or “invention” relate to exemplary embodiments and not necessarily to every embodiment encompassed by the appended claims.) More specifically, the present invention is related to a ladder stop which secures one or more ladders to a vehicle rack where the ladder stop can be easily positioned at essentially any location on a rail of the vehicle rack.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

When transporting one or more ladders from one remote location to another, vehicles are used to carry the ladders over distances that are basically just too far to walk. The ladders when they are transported by a vehicle are preferably not just put into or on the vehicle, where they might extend out of the vehicle or move around in the vehicle to damage the vehicle, but are by choice placed on some type of a rack to better secure the ladders to the vehicle to avoid damage to the vehicle or to the ladders or objects the ladders might strike it haphazardly extending out of the vehicle. Racks that have attachment devices, such as ladder stops, for attaching the ladders to the racks which are fixed in place, may at times not have enough attachment devices or not have the attachment devices in ideal or appropriate locations on the rack to best secure the ladders to the rack. It is desirable to have attachment devices or clamping type devices or ladder stops that can be easily attached to a rack at locations on the rack specifically chosen by the user to hold ladders, and then easily and quickly removed and put in a storage position when not needed to hold ladders to the rack.

### BRIEF SUMMARY OF THE INVENTION

The present invention pertains to a ladder stop for securing a ladder to a vehicle rack. The stop comprises a hook that contacts the ladder and holds the ladder to the rack. The stop comprises a clamp which removably attaches to the rack and from which the hook rotates and extends and moves up and down to hold the ladder. The stop comprises a locking mechanism that locks the hook in a desired position. The stop comprises a handle disposed adjacent a bottom of the hook for a user to grab and pull the hook down to secure the hook in place with the ladder.

The present invention pertains to a method for securing a ladder to a vehicle rack. The method comprises the steps of placing a rail of the rack in a clamp of a ladder stop. There is the step of attaching the clamp to the rail. There is the step of putting a locking mechanism of the ladder stop in an unlocked state. There is the step of moving a hook of the ladder stop down so the hook holds the ladder to the rack while the locking mechanism is in the unlocked state. There is the step of putting the locking mechanism into a locked state so the hook cannot move and the ladder is secured to the rack.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 shows the ladder stop and its component parts.

FIGS. 2A and 2B show the hook at full extension and full retraction respectively, and show that the hook can be rotated.

FIG. 3 shows a truck rack with two ladder stops clamped onto the rack rails.

### DETAILED DESCRIPTION OF THE INVENTION

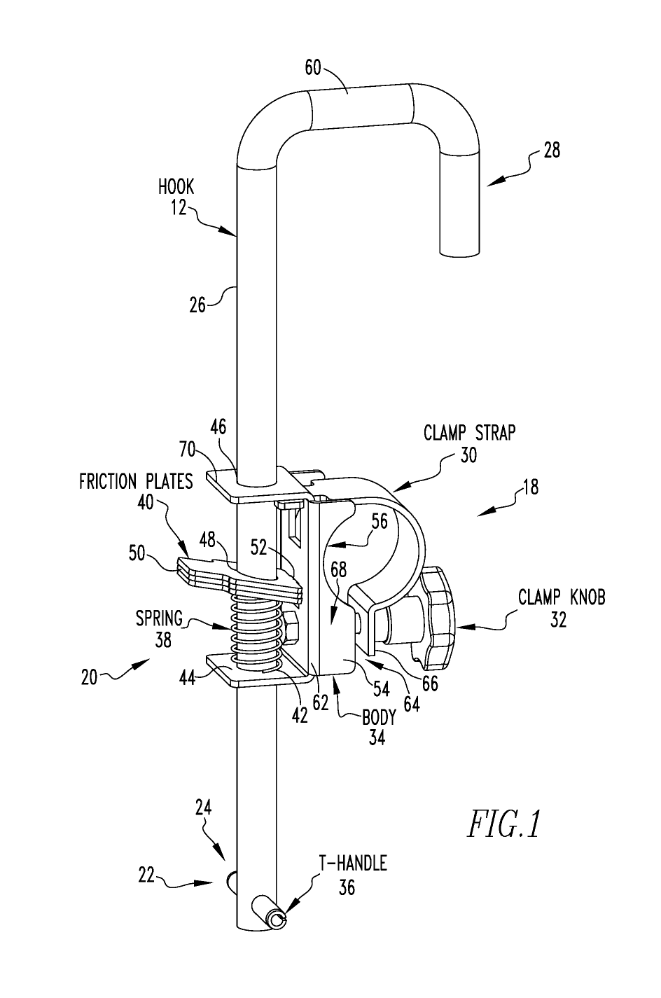

Referring now to the drawings wherein like reference numerals refer to similar or identical parts throughout the several views, and more specifically to FIGS. 1-3 thereof, there is shown a ladder stop 10 for securing a ladder 16 to a vehicle rack 14. The stop comprises a hook 12 that contacts the ladder 16 and holds the ladder 16 to the rack. The stop comprises a clamp 18 which removably attaches to the rack and from which the hook 12 rotates and extends and moves up and down to hold the ladder 16. The stop comprises a locking mechanism 20 that locks the hook 12 in a desired position. The stop comprises a handle 22 disposed adjacent a bottom 24 of the hook 12 for user grab and pull the hook 12 down to secure the hook 12 in place with the ladder 16.

The hook 12 may have a long arm 26 and a short arm 28 and a center member 60 connected to and between the long arm 26 and the short arm 28. The long arm 26 and short arm 28 in parallel and spaced relation. The short arm 28 shorter in length than the long arm 26. The long and short arms 26, 28 and center portion 62 are one continuous piece. The long arm 26 extending through the clamp 18 and able to rotate in and move and down the clamp 18 so the short arm 28 can be positioned about the ladder 16, with the ladder 16 disposed between the short arm 28 and the long arm 26 to secure the ladder 16 to the rack.

The clamp 18 may include a body 34 having a center portion 62, a top flange 70 extending from the center portion 62 and a bottom flange 44 extending from the center portion 62, with the center portion 62 between the top flange 70 and the bottom flange 44. The top flange 70 having a hole 46 through which the long arm 26 extends and the bottom flange 44 having a hole 42 through which the long arm 26 extends. The hole 46 of the top flange 70 in alignment with the hole 42 of the bottom flange 44.

The locking mechanism 20 may include a spring 38 positioned about the long arm 26 and disposed on the bottom flange 44, and a friction plate 40 having a hole 48 through which the long arm 26 extends so the friction plate 40 can move up and down the long arm 26. The friction plate 40 having a free end 50 and an engagement end 52 which contacts the center portion 62 and pushes against the center portion 62 from the force of the spring 38, which is disposed below and in contact with the friction plate 40. The engagement end 52 of the friction plate 40 locking the clamp 18 in position on the long arm 26 unless the free end 50 of the friction plate 40 is pushed down which releases the engagement end 52 from contact with the center portion 62 so the body 34 is able to move up and down the long arm 26 as long as the free end 50 is pushed down. The locking mechanism 20 may be put into the locked state by releasing the free end 50 of the friction plate 40 prior to pulling down on the handle of the hook to secure the ladder. The locking mechanism works like a one-way brake which makes tightening down the hook more convenient. More than one friction plate 40 may be used.

The clamp 18 may have a base 54 with a circular shaped opening 56 which conforms to a circular shaped rail 58 of the rack and receives the rail 58 when the clamp 18 is attached to the rack. The center portion 62 disposed between the base 54 and the long arm 26. The clamp 18 has a strap 30 attached to the base 54 above the circular shaped opening 56, and a knob 32 with a threaded end 64. The strap 30 has a bottom portion 66 through which the threaded end 64 of the knob 32 extends. The base 54 having a receiver 68 disposed below the circular shaped opening 56 which receives the threaded and of the knob 32. The strap 30 wrapping around the rail 58 when the rail 58 is disposed in the circular shaped opening 56 and securing the clamp 18 to the rail 58 when the threaded end 64 of the knob 32 is disposed in the receiver 68. The handle 22 may be a bar 36 that extends adjacent the bottom 24 of the long arm 26.

The present invention pertains to a method for securing a ladder 16 to a vehicle rack 14. The method comprises the steps of placing a rail 58 of the rack 14 in a clamp 18 of a ladder stop 10. There is the step of attaching the clamp 18 to the rail 58. There is the step of putting a locking mechanism 20 of the ladder stop 10 in an unlocked state. There is the step of moving a hook 12 of the ladder stop 10 down so the hook 12 holds the ladder 16 to the rack while the locking mechanism 20 is in the unlocked state. There is the step of putting the locking mechanism 20 into a locked state so the hook 12 cannot move and the ladder 16 is secured to the rack.

The moving the hook 12 step may include the step of positioning a short arm 28 of the hook 12 about the ladder 16 so the ladder 16 is positioned between the short arm 28 and a long arm 26 of the hook 12. The attaching step may include the steps of placing the rail 58 of the rack into a circular shaped opening 56 of a base 54 of a body 34 of the clamp 18, wrapping a strap 30 attached to the body 34 above the circular shaped opening 56 about the rod, and attaching a threaded and of a knob 32 that extends through a bottom 24 of the strap 30 into a receiver 68 in the body 34 located below the circular shaped opening 56 to clamp the clamp 18 to the rack.

The step of putting the locking mechanism 20 of the ladder stop 10 in the unlocked may include the step of pressing down on a free end 50 of a friction plate 40 through which the long arm 26 extends causing an engagement end 52 of the friction plate 40 to move out of contact with a center portion 62 of the base 54 of the body 34 so the center portion 62, which is movably attached to the long arm 26 through an upper flange and a lower flange that extends from the center portion 62, is able to move up and down relative to the long arm 26. The step of putting the locking mechanism 20 into the locked state so the hook 12 cannot move and the ladder 16 is secured to the rack may include the step of releasing the free end 50 of the friction plate 40 so a spring 38 positioned about the long arm 26 and disposed on the lower flange biases the engagement end 52 against the center portion 62 and holds the long arm 26 in place with the clamp 18.

A ladder stop 10 is a device used to securely hold a ladder 16 in place on a truck rack. The ladder stop 10 makes use of multiple friction plates 40 to allow rapid and convenient clamping action of a hook 12 in order to retain a ladder 16, or more than one ladder 16. In addition, this ladder stop 10 is designed to be easily repositioned on the truck rack to provide clamping where needed, or, to be placed in a stowed position when not needed. This invention provides a convenient and intuitive way to secure ladders onto the truck rack, doing away with the use of ropes, straps, chains, bungee cords, etc. Multiple ladder stops 10 may be used by customers for use on one truck rack.

FIG. 1 shows the ladder stop 10 and its component parts. The clamp strap 30 is drawn to the body 34 by turning the clamp knob 32. This clamping action secures the ladder stop 10 to a rail 58 of the truck rack. The hook 12 is free to rotate in the body 34 about its long axis and is free to be moved downward relative to the body 34. However, the friction plates 40, which are biased by the spring 38, prevent the hook 12 from moving upward unless the free end 50 of the friction plates 40 is deliberately pressed downward. The T-handle 22 provides a for the user to pull the hook 12 downward in order to secure a ladder 16 on the truck rack.

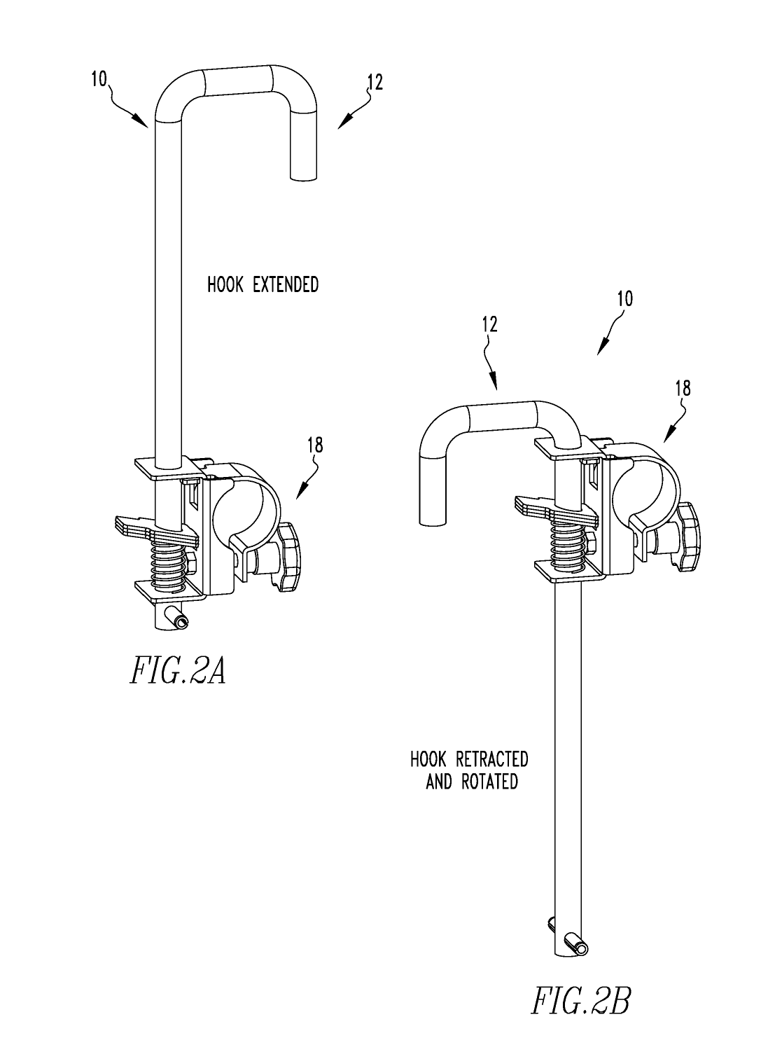

FIGS. 2A and 2B show the hook 12 at full extension and full retraction, respectively, and show that the hook 12 can be rotated.

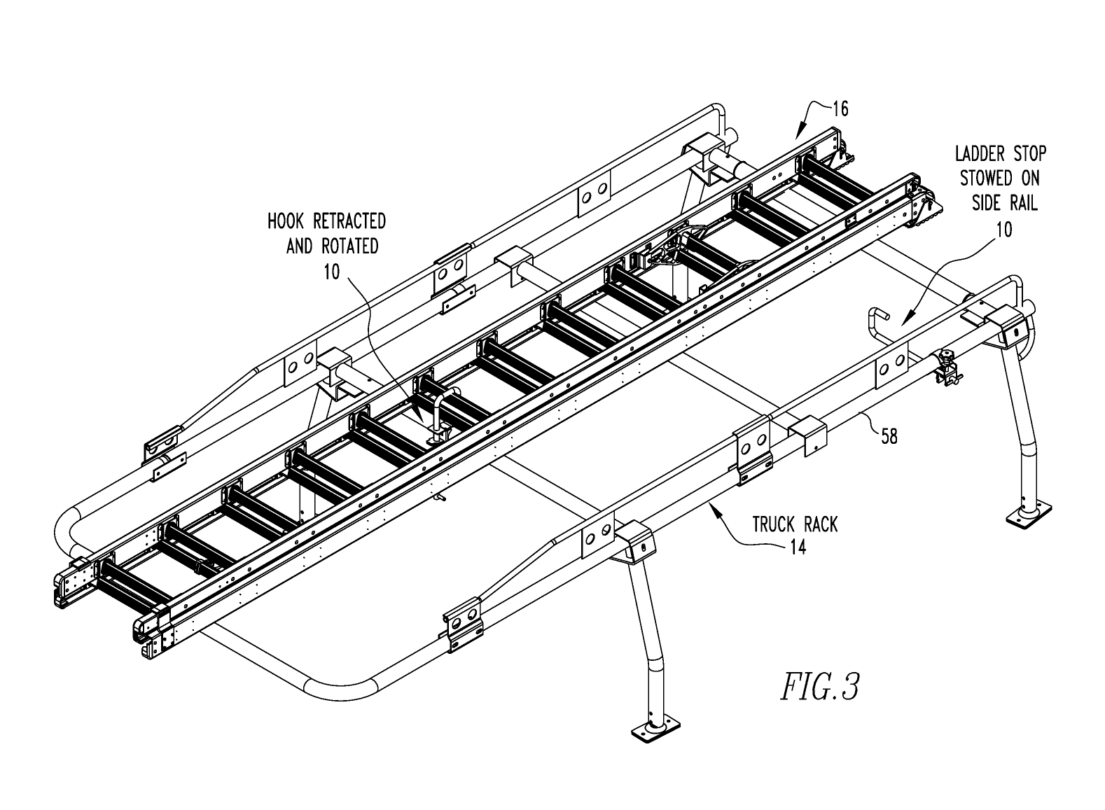

FIG. 3 shows a truck rack with two ladder stops 10 clamped onto the rack rails. One ladder stop 10 is clamped onto a transverse rail 58 of the rack and its hook 12 is adjusted to tightly hold onto the rungs of an extension ladder. The other ladder stop 10 is clamped onto side rail 58 of the rack and has been placed in an out-of-the-way position.

The diameter of the long arm 26, center member 60 and short a 28, which is cylindrical and made of either steel aluminum or hard plastic, is between 0.50 and 1.5 inches and preferably 0.75 inches. The center member 60 is between 2.5 inches and 5 inches and preferably 3.25 inches. The length of the short arm 28 is between 2 inches and 4 inches and preferably 2.625 inches. The length of the long arm 26 is between 14 inches and 19 inches and preferably 16.375 inches. The bar 36 of the handle 22 is between 2 inches and 4 inches and preferably 3 inches. The distance between the top flange 70 and the bottom flange 44 is between 3 inches and 5 inches and preferably 3.75 inches. The radius of the circle formed when the strap 30 is closed to the circular shaped opening 56 is whatever the radius of the rail 58 is to which the clamp 18 is being attached, and preferably is 1 inch. The distance between the tip of the knob 32 and the free end 50 is between 5 and 7 inches and preferably 5.828 inches. The radius of the knob 32 is between 0.5 inches and 1.5 inches and preferably 1 inch.

Although the invention has been described in detail in the foregoing embodiments or the purpose of illustration, it is to be understood that such detail is solely that purpose and that variations can be made therein by those skilled in the art without departing from the spirit and scope of the invention except as it may be described by the following claims.

1. A ladder stop for securing a ladder to a vehicle rack comprising:
a hook that contacts the ladder and holds the ladder to the rack;
a clamp which removably attaches to the rack and from which hook rotates and extends and moves up and down to hold the ladder;
a locking mechanism that locks the hook in a desired position; and
a handle disposed adjacent a bottom of the hook for a user to grab and pull the hook down to secure the hook in place with the ladder.

2. The ladder stop of claim 1 wherein the hook has a long arm and a short arm and a center member connected to and between the long arm and the short arm, the long arm and short arm in parallel and spaced relation, the short arm shorter in length than the long arm, the long and short arms and center portion are one continuous piece, the long arm extending through the clamp and able to rotate in and move up and down the clamp so the short arm can be positioned about the ladder, with the ladder disposed between the short arm and the long arm to secure the ladder to the rack.

3. The ladder stop of claim 2 wherein the clamp include a body having a center portion, a top flange extending from the center portion and a bottom flange extending from the center portion, with the center portion between the top flange and the bottom flange, the top flange having a hole through which the long arm extends in the bottom flange having a hole through which the long arm extends, the hole of the top flange in alignment with the hole of the bottom flange.

4. The ladder stop of claim 3 wherein the locking mechanism includes a spring positioned about the long arm and disposed on the bottom flange, and a friction plate having a hole through which the long arm extends so the friction plate can move up and down the long arm, the friction plate having a free end and an engagement end which contacts the center portion and pushes against the center portion from the force of the spring, which is disposed below and in contact with the friction plate, the engagement end of the friction plate locking the clamp in position on the long arm unless the free end of the friction plate is pushed down which releases the engagement end from contact with the center portion so the body is able to move up and down the long arm as long as the free end is pushed down.

5. The ladder stop of claim 4 wherein the clamp has a base with a circular shaped opening which conforms with a circular shaped rail of the rack and receives the rail when the clamp is attached to the rack, the center portion disposed between the base and the long arm, the clamp has a strap attached to the base above the circular shaped opening, and a knob with a threaded end, the strap has a bottom portion through which the threaded end of the knob extends, the base having a receiver disposed below the circular shaped opening which receives the threaded and of the knob, the strap wrapping around the rail when the rail, is disposed in the circular shaped opening and securing the clamp to the rail when the threaded end of the knob is disposed in the receiver.

6. The ladder stop of claim 5 wherein the handle is a bar that extends adjacent the bottom of the long arm.

7. A method for securing a ladder to a vehicle rack comprising the steps of:
placing a rail of the rack in a clamp of a ladder stop;
attaching the clamp to the rail;
putting a locking mechanism of the ladder stop in an unlocked state;
moving a hook of the ladder stop down so the hook holds the ladder to the rack while the locking mechanism is in the unlocked state; and
putting the locking mechanism into locked state so the hook cannot move and the ladder is secured to the rack.

8. The method of claim 7 wherein the moving the hook step includes the step of positioning a short arm of the hook about the ladder so the ladder is positioned between the short arm and a long arm of the hook.

9. The method of claim 8 wherein the attaching step includes the step of placing the rail of the rack into a circular shaped opening of a base of a body of the clamp, wrapping a strap attached to the body above the circular shaped opening about the rod, and attaching a threaded and of a knob that extends through a bottom of the strap into a receiver in the body located below the circular shaped opening to clamp the clamp to the rack.

10. The method of claim 9 wherein the step of putting the locking mechanism of the ladder stop in the unlocked includes the step of pressing down on a free end of a friction plate through which the long arm extends causing an engagement end of the friction plate to move out of contact with a center portion of the base of the body so the center portion, which is movably attached to the long arm through an upper flange and a lower flange that extends from the center portion, is able to move up and down relative to the long arm.

11. The method of claim 10 wherein the step of putting the locking mechanism into the locked state so the hook cannot move and the ladder is secured to the rack includes the step of releasing the free end of the friction plate so a spring positioned about the long arm and disposed on the lower flange biases the engagement end against the center portion and holds the long arm in place with the clamp.
